(19) United States
(12) Patent Application Publication
(10) Pub. No.: US 2023/0191821 A1
(43) Pub. Date: Jun. 22, 2023

(54) IDENTIFYING ALTERNATIVE SET OF DIGITAL ID DOCUMENTS USED TO VERIFY USER MEETS ID REQUIREMENTS FOR AN ASSOCIATED ACTIVITY OR EVENT

(71) Applicant: International Business Machines Corporation, Armonk, NY (US)

(72) Inventors: Swaminathan Balasubramanian, Troy, MI (US); Jason Malinowski, Mahopac, NY (US); Cheranellore Vasudevan, Bastrop, TX (US); Thomas G. Lawless, III, Wallkil, NY (US); Genevieve van den Boer, Richmond (CA); Gordan G. Greenlee, Endicott, NY (US)

(21) Appl. No.: 17/555,689

(22) Filed: Dec. 20, 2021

(51) Int. Cl. B42D 25/22; B42D 25/23; G06F 16/383

(52) U.S. Cl. CPC B42D 25/22; B42D 25/23; G06F 16/383

(57) ABSTRACT

A computer-implemented method, system and computer program product for verifying a user meets identification (ID) requirements for an associated activity or event. A request for a set of digital ID documents to be provided to the computing device of the verifier by the computing device of the device holder is detected. A response to the request is then detected which provides only a subset of the requested digital ID documents. Alternative digital ID document(s) are then identified to replace the digital ID document(s) that were requested but not provided by the device holder. An instruction is then issued to the computing device of the verifier to request one or more of the identified alternative digital ID documents from the computing device of the device holder in order to complete the verification process in determining if the device holder meets the ID requirements for an associated activity or event.

### TECHNICAL FIELD

The present disclosure relates generally to identification (ID) documents, and more particularly to verifying that a user meets the ID requirements for an associated activity or event using an alternative set of digital ID documents than previously requested by the verifier.

### BACKGROUND

Currently, institutions, such as government agencies (e.g., department of motor vehicles), issue identity or identification cards or documents which may be used to identify a person or verify aspects of a person's personal identity. Identity or identification documents may include, for example, a driver's license, a fishing license, a hunting license, a passport, a health insurance card, a firearm owner's identification card, a boating license, a commercial driver's license, etc. Typically, such documents are issued in the form of a thermal plastic card or paper by these institutions (also referred to as “issuer”) based on user data (e.g., name, address, birthdate, height, etc. of the user) stored in databases.

### SUMMARY

In one embodiment of the present disclosure, a computer-implemented method for verifying a user meets identification (ID) requirements for an associated activity or event comprises detecting a request for a set of digital ID documents to be provided to a computing device of a verifier by a computing device of a device holder in order to verify the device holder meets the ID requirements for the associated activity or event. The method further comprises detecting a response to the request that provides a subset of the set of digital ID documents to the computing device of the verifier from the computing device of the device holder. The method additionally comprises identifying one or more alternative digital ID documents to replace one or more digital ID documents in the set of digital ID documents that were requested but not provided in the subset of the set of digital ID documents. Furthermore, the method comprises instructing the computing device of the verifier to complete verification of the device holder meeting the ID requirements for the associated activity or event by requesting one or more of the one or more alternative digital ID documents from the computing device of the device holder.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components used by the authentication system for identifying alternative digital ID documents to be provided to the verifier in order to complete the verification process in determining if the device holder meets the ID requirements for an associated activity or event in accordance with an embodiment of the present disclosure;

FIG. 3 illustrates an embodiment of the present disclosure of the hardware configuration of the authentication system which is representative of a hardware environment for practicing the present disclosure;

FIG. 4 is a flowchart of a method for creating an artificial intelligence model for identifying alternative digital ID documents in accordance with an embodiment of the present disclosure; and

FIGS. 5A-5B are a flowchart of a method for verifying that a user meets the ID requirements for an associated activity or event using alternative digital ID documents in accordance with an embodiment of the present disclosure.

### DETAILED DESCRIPTION

As stated in the Background section, currently, institutions, such as government agencies (e.g., department of motor vehicles), issue identity or identification cards or documents which may be used to identify a person or verify aspects of a person's personal identity. Identity or identification documents may include, for example, a driver's license, a fishing license, a hunting license, a passport, a health insurance card, a firearm owner's identification card, a boating license, a commercial driver's license, etc. Typically, such documents are issued in the form of a thermal plastic card or paper by these institutions (also referred to as “issuer”) based on user data (e.g., name, address, birthdate, height, etc. of the user) stored in databases.

Unfortunately, by relying upon thermal plastic cards or paper, there are several drawbacks. For example, when a user presents an identity or identification document, such as to a verifier (responsible for determining if the user meets the identification (ID) requirements for an associated activity or event, such a merchant), there is no choice but to present the entire identity or identification document which may include personal information that is not needed to be seen by the verifier. For example, a merchant does not need to know the address of the individual when the individual is purchasing alcoholic beverages to verify that the individual is over 21 years of age. However, when the individual presents a driver's license to the merchant, the merchant will have access to information besides the age of the individual, such as the name and address of the individual.

As a result, technologies, such as IBM® Verify Credentials, were developed to support a trusted, secure ecosystem for the management and exchange of “digital identifications” (also referred to as “digital IDs,” “digital ID documents” or “digital identification documents”). A digital ID document is the electronic equivalent of an individual identity card as well as other forms of user information, such as pay stubs, utility bills, restaurant receipts, etc. A digital ID document can be presented electronically to prove an individual's identity and/or their right to partake in an activity or event or to access information or services. Furthermore, the digital ID document can include attributes selected by the user to be presented to the verifier, such as the age of the user, thereby preventing other information that was not selected by the user (e.g., home address) from being shared to the verifier. As a result, the user has control as to what personal information will be shown to the verifier.

However, there are times when the user may desire to provide alternative digital ID documents than the digital ID documents requested by the verifier. For example, the user may not possess the requested “standard ID” or may be reluctant to show such document(s) to the verifier.

Unfortunately, there is not currently a means for identifying such alternative electronic documents (digital ID documents) to be provided to the verifier in order to complete the verification process in determining if the user meets the ID requirements for an associated activity or event.

The embodiments of the present disclosure provide a means for identifying alternative digital ID documents to be provided to the verifier in order to complete the verification process in determining if the user meets the ID requirements for an associated activity or event.

In some embodiments of the present disclosure, the present disclosure comprises a computer-implemented method, system and computer program product for verifying a user meets the identification (ID) requirements for an associated activity or event. In one embodiment of the present disclosure, a request for a set of digital ID documents (e.g., utility bill, driver's license, birth certificate) to be provided to the computing device of the verifier by the computing device of the device holder in order to verify that the user (or “device holder”) meets the ID requirements for an associated activity or event is detected. A response to the request is then detected which provides only a subset of the requested digital ID documents. One or more alternative digital ID documents are then identified to replace the digital ID document(s) that were requested but not provided by the device holder. In one embodiment, such alternative digital ID document(s) are identified using an artificial intelligence model based on various factors, such as the type of transaction, the purpose for verifying that the device holder meets the ID requirements for an associated event or activity, a trust level and/or a confidence level. The “type of transaction,” as used herein, refers to the categorization of the device holder (e.g., government employee) involved in the communication with the verifier. In one embodiment, the “trust level” refers to the level of probability in which the alternative set of digital ID document(s) will be accepted by the verifier to replace those digital ID documents that were previously requested by the verifier but not provided by the device holder. The “confidence level,” as used herein, refers to a confidence that the verifier has in verifying that the device holder meets the ID requirements for an associated activity or event using the alternative set of digital ID document(s). An instruction is then issued to the computing device of the verifier to request one or more of the identified alternative digital ID documents from the computing device of the device holder in order to complete the verification process in determining if the device holder meets the ID requirements for an associated activity or event. In this manner, the principles of the present disclosure identify digital ID documents to replace those digital ID documents that were requested by the verifier but not provided by the user. Such replacement digital ID documents may then be requested by the verifier to be provided by the user in order to complete the verification process in verifying that the user has met the ID requirements for an associated activity or event.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill the relevant art.

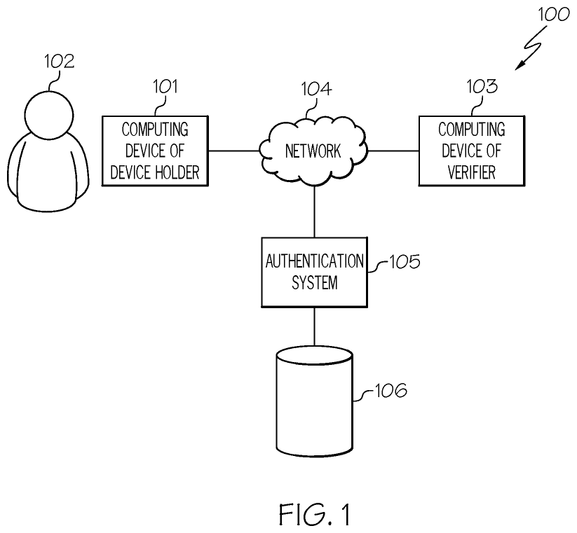

Referring now to the Figures in detail, FIG. 1 illustrates an embodiment of the present disclosure of a communication system 100 for practicing the principles of the present disclosure. Communication system 100 includes a computing device 101 of a user 102 (referred to herein as the “device holder”) connected to a computing device 103 of a “verifier” via a network 104. User (“device holder”) 102, as used herein, refers to the individual who desires to partake in an activity or event but is required to present digital ID documents to the verifier (e.g., government agency) to prove that device holder 102 meets the ID requirements (“ID requirements”) to engage in such an activity or event. “Verifier,” as used herein, refers to the entity (e.g., government agency, government official, merchant, etc.) that is responsible for verifying that device holder 102 meets the ID requirements for partaking in an associated activity or event.

Computing devices 101, 103 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of connecting to network 104 and consequently communicating with verifiers and device holders 102, respectively.

Network 104 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Furthermore, network 104 may consist of a wireless network to support wireless technology standards or protocols, such as Bluetooth and near-field communication. Other networks, whose descriptions are omitted here for brevity, may also be used in conjunction with system 100 of FIG. 1 without departing from the scope of the present disclosure.

Furthermore, as shown in FIG. 1, system 100 includes an authentication system 105 connected to network 104 via wire or wirelessly. Authentication system 105 is configured to identify alternative digital ID documents to be provided to the verifier in order to complete the verification process in determining if device holder 102 meets the ID requirements for an associated activity or event as discussed further below. In connection with identifying such alternative digital ID documents, authentication system 105 may utilize “ID records” that include historical data of acceptable credentials and their contexts which are stored in database 106 connected to authentication system 105.

“ID records,” as used herein, refer to the collection of digital ID documents, including alternative digital ID documents, that were provided by device holders, such as device holder 102 of FIG. 1, to verifiers. “Alternative digital ID documents,” as used herein, refer to digital ID documents (e.g., pay sub issued in the last 7 days) that are requested by the verifier to be provided by the device holder, such as device holder 102, in replace of the digital ID documents (e.g., debit card of a designated bank) that were originally requested by the verifier to be provided by the device holder. Furthermore, such ID records include information, such as the type of transaction (referred to herein also as the “client type”). The “type of transaction,” as used herein, refers to the categorization of the device holder (e.g., government employee) involved in the communication with the verifier. For example, the transaction between the verifier and device holder 102 may involve device holder 102 being a government employee. Additionally, such ID records may include the purpose for verifying that device holder 102 meets the ID requirements for an associated activity or event, such as opening a checking account. Furthermore, such ID records include a listing of digital ID documents that were deemed acceptable credentials for verifying that device holder 102 meets the ID requirements for an associated activity or event, such as a government issued badge, a pay stub issued in the last 7 days, a debit card, etc., as well as the contents of such digital ID documents. Such information may be associated with the collection of digital ID documents that were previously selected by authentication system 105 to be recommended to the verifier to complete the verification process in determining if the device holder meets the ID requirements for an associated activity or event as discussed further below.

An example of such an ID record is provided below:

```
{“case_id”: “123”,
  “provider_name”: “abc bank”,
  “provider_type”: {“bank”, “financial”},
  “client_id”: “456,”
  “client_type”: “government employee”,
  “purpose”: “open checking account”,
  “ID docs accepted”: {“government issued badge”, “pay stub issued in
last 7 days”, “debit card of a bank”}
}
```

Furthermore, in one embodiment, such ID records may include the trust level in using alternative digital ID documents in determining whether the device holder meets the ID requirements for an associated activity or event. As discussed above, in one embodiment, the “trust level” refers to the level of probability in which the alternative set of digital ID document(s) will be accepted by the verifier to replace those digital ID documents that were previously requested by the verifier but not provided by the device holder.

Additionally, in one embodiment, such ID records may include the confidence level corresponding to a confidence that the verifier has in verifying that the device holder meets the ID requirements for an associated activity or event using such an alternative set of digital ID documents.

Such information (e.g., trust level, confidence level) may be associated with the collection of digital ID documents that were previously selected by authentication system 105 to be recommended to the verifier to complete the verification process in determining if the device holder meets the ID requirements for an associated activity or event as discussed further below.

Additionally, in one embodiment, database 106 further stores the profiles of the device holders that contain information about the device holders, such as the client type (e.g., government employee). In one embodiment, such profiles are populated by the device holders upon utilizing system 100 to interact with computing device 103 of a verifier in order for the verifier to determine if such a device holder 102 meets the ID requirements for an associated activity or event.

Additionally, in one embodiment, database 106 stores the profiles of the verifiers, such as the corporate size of the verifier (e.g., national retail chain versus a local hardware store), the type of corporate entity (e.g., privately held company, government institution), the location of the verifier (e.g., local government, foreign government), etc. In one embodiment, such profiles are populated by the verifiers upon utilizing system 100 to interact with computing device 101 of device holder 102 in order for the verifier to determine if such a device holder 102 meets the ID requirements for an associated activity or event.

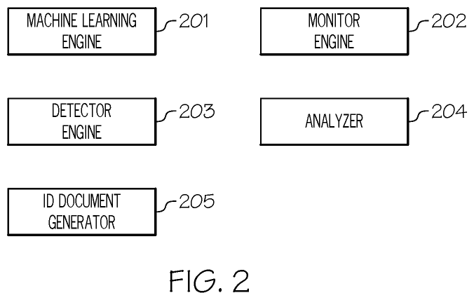

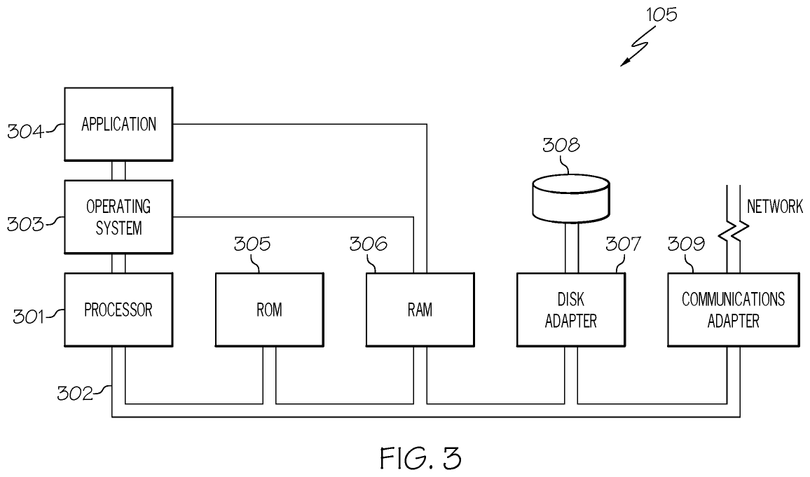

A description of the software components of authentication system 105 used for identifying alternative digital ID documents to be provided to the verifier in order to complete the verification process in determining if device holder 102 meets the ID requirements for an associated activity or event is provided below in connection with FIG. 2. A description of the hardware configuration of authentication system 105 is provided further below in connection with FIG. 3.

System 100 is not to be limited in scope to any one particular network architecture. System 100 may include any number of computing devices 101, 103, device holders 102, networks 104, authentication systems 105 and databases 106.

As stated above, FIG. 2 is a diagram of the software components used by authentication system 105 (FIG. 1) for identifying alternative digital ID documents to be provided to the verifier in order to complete the verification process in determining if the device holder (e.g., device holder 102) meets the ID requirements for an associated activity or event in accordance with an embodiment of the present disclosure;

Referring to FIG. 2, in conjunction with FIG. 1, authentication system 105 includes a machine learning engine 201 configured to use a machine learning algorithm (e.g., supervised learning) to build an artificial intelligence model based on sample data consisting of digital ID documents, including alternative digital ID documents, that were requested by the verifiers and provided by the device holders as well as the associated type of transaction, the purpose for verifying that the device holder (e.g., device holder 102) meets the ID requirements for an associated activity or event, the trust level (e.g., level of probability in which the alternative set of digital ID document(s) will be accepted by the verifier to replace those digital ID documents that were previously requested by the verifier but not provided by the device holder) and a confidence level (confidence that the verifier has in verifying that the device holder meets the ID requirements for an associated activity or event using such an alternative set of digital ID documents). As previously discussed, such information may be stored in the ID records which are stored in database 106.

Such a data set is referred to herein as the “training data,” which is used by the machine learning algorithm to make predictions or decisions as to the appropriate alternative set of digital ID documents to be recommended to replace those digital ID documents that were requested by the verifier but not provided by the device holder. In one embodiment, the training data consists of digital ID documents, including alternative digital ID documents, that was requested by the verifier and provided by the device holder as well as the associated type of transaction, the purpose for verifying that the device holder (e.g., device holder 102) meets the ID requirements for an associated activity or event, a trust level (e.g., level of probability in which the alternative set of digital ID document(s) will be accepted by the verifier to replace those digital ID documents that were previously requested by the verifier but not provided by the device holder) and a confidence level (confidence that the verifier has in verifying that the device holder meets the ID requirements for an associated activity or event using such an alternative set of digital ID documents). The algorithm iteratively makes predictions on the training data as to the appropriate alternative set of digital ID documents to be recommended to replace those digital ID documents that were requested by the verifier but not provided by the device holder. Examples of such supervised learning algorithms include nearest neighbor, Naïve Bayes, decision trees, linear regression, support vector machines and neural networks.

In one embodiment, the artificial intelligence model (machine learning model) corresponds to a classification model trained to predict which digital ID documents should be recommended to replace those digital ID documents that were requested by the verifier but not provided by the device holder.

In one embodiment, the trust level is determined based on prior uses of such alternative digital ID documents to replace those digital ID documents that were previously requested by the verifier but not provided by the device holder. As discussed above, in one embodiment, the “trust level” refers to the level of probability in which the alternative set of digital ID document(s) will be accepted by the verifier to replace those digital ID documents that were previously requested by the verifier but not provided by the device holder. In one embodiment, such a trust level is established by machine learning engine 201 using a machine learning algorithm (e.g., supervised learning) to build a trust model based on sample data consisting of the alternative set of digital ID documents that were selected to replace those digital ID documents that were previously requested by the verifier but not provided by the device holder as well as the acceptance rate of such alternative digital ID documents by the verifier. The “acceptance rate,” as used herein, refers to the rate that such selected alternative digital ID documents were requested by the verifier to be provided by the device holder to complete the verification process in determining whether the device holder meets the ID requirements for an associated activity or event. Such a data set is referred to herein as the “training data,” which is used by the machine learning algorithm to make predictions or decisions as to the probability in which an alternative set of digital ID documents will be accepted by the verifier to replace those digital ID documents that were previously requested by the verifier but not provided by the device holder. The algorithm iteratively makes predictions on the training data as to the probability in which an alternative set of digital ID documents will be accepted by the verifier to replace those digital ID documents that were previously requested by the verifier but not provided by the device holder. Examples of such supervised learning algorithms include nearest neighbor, Naïve Bayes, decision trees, linear regression, support vector machines and neural networks.

In one embodiment, the trust model (machine learning model) corresponds to a classification model trained to predict the probability in which an alternative set of digital ID documents will be accepted by the verifier to replace those digital ID documents that were previously requested by the verifier but not provided by the device holder.

In one embodiment, the trust level is a bidirectional trust index that is based on the classification of the verifier and the device holder, such as device holder 102. Such a bidirectional trust index refers to the reliability in effectively verifying by the verifier that the device holder meets the ID requirements for an associated activity or event using the digital ID documents provided by the device holder.

In one embodiment, the classification for the verifier is based on data, such as based on the corporate size of the verifier (e.g., national retail chain versus a local hardware store), the type of corporate entity (e.g., privately held company, government institution), the location of the verifier (e.g., local government, foreign government), etc. Such information regarding the classification of the verifier may be obtained from the profile of the verifier, which is populated by the verifier upon utilizing system 100 to interact with computing device 101 of device holder 102 in order for the verifier to determine if such a device holder 102 meets the ID requirements for an associated activity or event.

Furthermore, the classification of the device holder, such as device holder 102, may be based on the geolocation data, the percentage of negotiations involving a verifier in which the device holder was deemed to be trusted, etc. In one embodiment, such geolocation data is obtained from monitor engine 202 as discussed further below. Furthermore, the percentage of negotiations involving a verifier in which the device holder was deemed to be trusted, etc. is based on historical records (e.g., ID records) stored in database 106 associated with such a device holder, which are established by detector engine 203 as discussed further below.

As discussed above, the trust level is a bidirectional trust index that is based on the classification of the verifier and the device holder, such as device holder 102. For example, a verifier that is a foreign government may have a lower trust level (lower trust level index) than a local government as there may be an increased risk of the device holder not providing the requested digital ID documents to a foreign government versus a local government. In another example, a device holder that has engaged in numerous successful negotiations with the verifier (e.g., numerous successful verification processes in which the device holder was successfully verified to meet the ID requirements for an associated activity or event) may have a higher trust level (higher trust level index) than if the device holder only had a single successful verification process with the verifier.

In one embodiment, the trust model is built based on sample data consisting of the reliability in effectively verifying by the verifier that the device holder meets the ID requirements for an associated activity or event using the digital ID documents provided by the device holder based on different classifications of the device holder and the verifier. Such a data set is referred to herein as the “training data,” which is used by the machine learning algorithm to make predictions or decisions as to the trust level or the reliability in effectively verifying by the verifier that the device holder meets the ID requirements for an associated activity or event using the digital ID documents provided by the device holder based on such classifications. The algorithm (supervised learning algorithm) iteratively makes predictions on the training data as to the trust level or probability in effectively verifying by the verifier that the device holder meets the ID requirements for an associated activity or event using the digital ID documents provided by the device holder based on classifications of the device holder and the verifier. Examples of such supervised learning algorithms include nearest neighbor, Naïve Bayes, decision trees, linear regression, support vector machines and neural networks.

In one embodiment, the trust model (machine learning model) corresponds to a classification model trained to predict the trust level or probability in effectively verifying by the verifier that the device holder meets the ID requirements for an associated activity or event using the digital ID documents provided by the device holder based on the classifications of the device holder and the verifier.

In one embodiment, the bidirectional trust index is utilized to determine whether it is safe to share requested digital ID documents by the device holder to the verifier based on the trust index of the verifier and whether it is safe to request digital ID documents from the device holder by the verifier based on the trust index of the device holder. For example, authentication system 105 may inform the device holder, such as device holder 102, via computing device 101 that it is safe to share the requested digital ID documents to the verifier since the trust index for the verifier indicates a high level of trust. Conversely, authentication system 105 may inform the device holder, such as device holder 102, via computing system 101 that is not safe to share the requested digital ID documents to the verifier since the trust index for the verifier indicates a low level of trust. In another example, authentication system 105 may inform the verifier via computing device 103 that it is safe to request and receive the digital ID documents, including alternative digital ID documents, from the device holder, such as device holder 102, since the trust index for the device holder indicates a high level of trust. Conversely, authentication system 105 may inform the verifier via computing device 103 that it is not safe to request and receive the digital ID documents, including alternative digital ID documents, from the device holder, such as device holder 102, since the trust index for the device holder indicates a low level of trust.

Furthermore, as discussed above, a confidence level may be used by machine learning engine 201 to identify an alternative set of digital ID documents. The “confidence level,” as used herein, refers to a confidence that the verifier has in verifying that the device holder meets the ID requirements for an associated activity or event using the alternative set of digital ID documents. In one embodiment, such a confidence level may be expressed in terms of a probability, such as a probability in successfully completing the verification process in verifying that the device holder meets the ID requirements for an associated activity or event using such alternative digital ID documents.

In one embodiment, such a confidence level is established by machine learning engine 201 using a machine learning algorithm (e.g., supervised learning) to build a confidence model based on sample data consisting of the alternative set of digital ID documents that were selected to replace those digital ID documents that were previously requested by the verifier but not provided by the device holder as well as the success rate in completing the verification process in verifying that the device holder meets the ID requirements for an associated activity or event using such alternative digital ID documents. The “success rate,” as used herein, refers to the rate that the verification process successfully verified that the device holder meets the ID requirements for an associated activity or event using such alternative digital ID documents. Such a data set is referred to herein as the “training data,” which is used by the machine learning algorithm to make predictions or decisions as to the confidence level or probability in which the verification process successfully verified that the device holder meets the ID requirements for an associated activity or event using the alternative set of digital ID documents. The algorithm iteratively makes predictions on the training data as to the confidence level or probability in which the verification process successfully verified that the device holder meets the ID requirements for an associated activity or event using the alternative set of digital ID documents. Examples of such supervised learning algorithms include nearest neighbor, Naïve Bayes, decision trees, linear regression, support vector machines and neural networks.

In one embodiment, the confidence model (machine learning model) corresponds to a classification model trained to predict the confidence level or probability in which the verification process successfully verified that the device holder meets the ID requirements for an associated activity or event using the alternative set of digital ID documents.

In one embodiment, the confidence level outputted by the confidence model corresponds to a value or score, such as a number between 0 and 1, which represents the likelihood that the verification process successfully verified that the device holder meets the ID requirements for an associated activity or event using the alternative set of digital ID documents. In one embodiment, each prediction has a confidence score. In one embodiment, the lower the confidence score, the lower the confidence that the verification process will successfully verify that the device holder meets the ID requirements for an associated activity or event using the alternative set of digital ID documents. Conversely, the higher the confidence score, the higher the confidence that the verification process will successfully verify that the device holder meets the ID requirements for an associated activity or event using the alternative set of digital ID documents.

Exemplary software tools for creating such confidence models include, but not limited to, ThingWorx® Composer, PI System®, Mosaic®, etc.

In one embodiment, the artificial intelligence model provides a listing of the alternative digital ID documents in a ranked order based on the likelihood that such alternative digital ID documents will be accepted by the verifier and the likelihood that such alternative digital ID documents will be successful in verifying that the device holder meets the ID requirements for an associated activity or event using such alternative digital ID documents. In one embodiment, such ranking is based on the trust level and the confidence level as established by the trust and confidence models discussed above. In one embodiment, the higher the ranking, the greater the likelihood that the associated alternative digital ID document will be accepted by the verifier and will be used in successfully verifying that the device holder meets the ID requirements for an associated activity or event. Conversely, the lower the ranking, the lesser the likelihood that the associated alternative digital ID document will be accepted by the verifier and will be used in successfully verifying that the device holder meets the ID requirements for an associated activity or event.

Authentication system 105 further includes a monitor engine 202 configured to monitor for the establishment of a communication connection between computing device 101 of the device holder, such as device holder 102, and computing device 103 of the verifier. Such connections may involve the establishment of a communication between such computing devices via various means, such as Bluetooth, cellular, near-field communication, etc.

Such monitoring may be accomplished by monitor engine 202 using various software tools, including, but not limited to, SolarWinds® Server & Application Monitor, Datadog®, Zabbix®, Dynatrace®, LogicMonitor®, Sumo Logic®, etc.

In one embodiment, such monitoring may include obtaining the geolocation information of computing device 101 of device holder 102 and the geolocation information of computing device 103 of the verifier. A “geolocation,” as used herein, refers to the geographical (latitudinal and longitudinal) location of a network connected device. In one embodiment, such geolocation information is obtained by monitor engine 202 via a geolocation API which requests permission from the browser of computing devices 101, 103 to access their location data. In one embodiment, such geolocation information forms part of the device holder's response to the verifier's request for providing the digital ID documents.

Authentication system 105 additionally includes a detector engine 203 configured to detect a request for a set of digital ID documents to be provided by computing device 101 of device holder 102 to computing device 103 of the verifier. Furthermore, detector engine 203 is configured to detect a response to such a request by computing device 101 of device holder 102.

Such detecting may be accomplished by detector engine 203 using various software tools including, but not limited to, SolarWinds® Network Performance Monitor, Paessler® Network Monitor, ManageEngine® NetFlow Analyzer, Savvius Omnipeek, Wireshark®, Telerik® Fiddler, Colasoft® Capsa, etc.

In one embodiment, detector engine 203 is configured to determine the type of transaction involved in the communication between the verifier and device holder 102 based on reviewing the profile of device holder 102 stored in database 106 that contains information about the device holder, such as the client type (e.g., government employee). In one embodiment, such a profile was populated by device holder 102 upon utilizing system 100 to interact with computing device 103 of the verifier in order for the verifier to determine if device holder 102 meets the ID requirements for an associated activity or event. In one embodiment, the transaction type is identified in the profile associated with the device holder in question using natural language processing in which keywords, such as “transaction type” or “client type,” in the profile are identified thereby enabling detector engine 203 to determine the type of transaction based on the word(s) following such keywords in the profile. In one embodiment, such information is used to populate an ID record associated with the device holder involved in such a communication.

In one embodiment, detector engine 203 is configured to determine the purpose for verifying that the device holder (e.g., device holder 102) meets the ID requirements for an associated activity or event based on the activity or event mentioned in the request provided by the verifier to the device holder, such as device holder 102. In one embodiment, detector engine 203 uses natural language processing to identify such activities or events. In one embodiment, a data structure (e.g., table) contains a listing of keywords (e.g., “opening checking account”) associated with various activities or events. In one embodiment, such a data structure is populated by an expert. In one embodiment, detector engine 203 analyzes the request issued by the verifier to identify such keywords listed in the data structure using natural language processing thereby identifying the purpose for verifying that the device holder (e.g., device holder 102) meets the ID requirements for an associated activity or event. In one embodiment, such information is used to populate an ID record associated with the device holder involved in such a communication.

Furthermore, authentication system 105 includes an analyzer 204 configured to determine whether there has been any previously established trust relationship between the verifier (e.g., Home Depot®) or a related third party (e.g., Lowes®) and device holder 102 upon detector engine 203 detecting a request issued by the verifier to device holder 102 to provide a set of digital ID documents to the verifier.

In one embodiment, previously established trust relationships between verifiers and device holders are stored in database 106, such as in a data structure (e.g., table). A “trust relationship,” as used herein, refers to a secure communication channel between computing device 103 of a verifier and computing device 101 of a device holder, such as device holder 102, in which the sending of digital ID documents (requested by the verifier) to the verifier by the device holder, such as device holder 102, is permitted to occur. In one embodiment, such trust relationships may be detected by detector engine 203 based on detecting the requests and responses between the verifier and the device holder. Such information may be populated in a data structure (e.g., table) that includes a listing of verifiers with established trust relationships with various device holders. In one embodiment, such a data structure resides in a storage device (e.g., memory, disk unit) of authentication system 105.

Furthermore, in one embodiment, verifiers may be cross-referenced with other verifiers in the data structure that are related, such as by industry. For example, the verifier of Home Depot® may be deemed to be related to the verifier of Lowes® since both merchants are in the home improvement service. In one embodiment, such cross-referencing is populated in the data structure by an expert. In one embodiment, such cross-referencing is stored in a list maintained in the data structure discussed above or in a separate data structure (e.g., table). Such a separate data structure may also be stored in a storage device (e.g., memory, disk unit) of authentication system 105. As a result, if a device holder has a trust relationship with Home Depot®, then such a trust relationship may be deemed to be valid with Lowes® even though the device holder may not have previously provided digital ID documents to such a merchant.

In one embodiment, upon detector engine 203 detecting a request issued by the verifier to device holder 102 to provide a set of digital ID documents to the verifier, analyzer 204 is configured to search in the data structure discussed above for a matching pair of the verifier (or related verifier) and device holder involved in the detected request. For example, if the request involves the verifier of Home Depot® and the device holder, then analyzer 204 is configured to search in the data structure for a matching pair of the verifiers Home Depot® or Lowes® (related verifier) and the device holder.

If such a matching pair is identified in the data structure, then analyzer 204 is configured to inform the verifier of a previously established trust relationship between the verifier (or a related third party verifier) and the device holder thereby recommending that a subset of the digital ID documents are not required. In one embodiment, such a recommended set of digital ID documents corresponds to those digital ID documents that were previously provided by the device holder to the verifier (or a related third party verifier) as indicated in the ID records of database 106. For example, the identifications of the particular digital ID documents that were provided by the device holder to the verifier (or related third party verifier) may have been previously stored in the ID record associated with such a validation process.

Furthermore, in one embodiment, after detector engine 203 detects a response by computing device 101 of device holder 102 to the request to provide a set of digital ID documents issued by the verifier, analyzer 204 is configured to determine if the response provides a subset of the digital ID documents requested by the verifier. For example, the verifier may have requested the digital ID documents of a government issued badge and a pay stub issued in the last 7 days. However, device holder 102 may have only provided a government issued badge.

In one embodiment, such a determination is performed by analyzer 204 utilizing natural language processing to identify a list of digital ID documents requested by the verifier for device holder 102 to provide and to identify which digital ID documents from the list of digital ID documents were actually provided by device holder 102 in the response.

In one embodiment, a possible list of digital ID documents to be requested by the verifier and provided by the device holder is listed in a data structure (e.g., table). In one embodiment, such a data structure is populated by an expert. In one embodiment, analyzer 204 is configured to identify a digital ID document requested by the verifier in the request issued by the verifier by matching a term in the request with one of the keywords in the data structure that identifies a digital ID document using natural language processing. Furthermore, in one embodiment, analyzer 204 is configured to identify a digital ID document in the response issued by the device holder, such as device holder 102, by matching a term in the response with one of the keywords in the data structure that identifies a digital ID document using natural language processing. By comparing such digital ID documents identified in the request and response, analyzer 204 determines which, if any, of the digital ID documents that were requested by the verifier were not provided by the device holder. In one embodiment, such a data structure is stored in the storage device (e.g., memory, disk unit) of authentication system 105.

If analyzer 204 determines that a subset of the digital ID documents that were requested by the verifier were not provided by device holder 102, including identifying which particular digital ID documents were not provided by device holder 102, then ID document generator 205 of authentication system 105 determines if there are any alternative digital ID documents to provide to the verifier to replace those digital ID documents that were requested by the verifier but not provided by device holder 102.

In one embodiment, a data structure (e.g., table) may be populated with a listing of digital ID documents as well as a listing of digital ID documents that could be provided as a substitute for such digital ID documents. In one embodiment, such a data structure is populated by an expert. In one embodiment, such a data structure resides within the storage device (e.g., memory, disk unit) of authentication system 105.

In one embodiment, after determining by analyzer 204 as to which digital ID documents were not provided by device holder 102 as requested by the verifier, ID document generator 205 is configured to search and identify such digital ID documents in the data structure listed above using natural language processing to determine if there any alternative digital ID documents that could be provided as a substitute for such digital ID documents. For example, the data structure may include an entry of the digital ID document of a pay stub for the last 7 days as well as an entry for a debit card of a bank as a substitute for a pay stub for the last 7 days.

In one embodiment, ID document generator 205 identifies alternative digital ID documents, if any, based on inquiring the artificial intelligence model built by machine learning engine 201 to identify alternative digital ID documents to replace those digital ID documents that were requested by the verifier but not provided by device holder 102. In one embodiment, ID document generator 205 inputs various information to the model, such as the digital ID documents that were not provided by device holder 102 as requested by the verifier, the type of transaction (e.g., government employee) and/or the purpose for verifying that the device holder (e.g., device holder 102) meets the ID requirements for an associated activity or event. The listing of the digital ID documents that were not provided by device holder 102 is obtained by analyzer 204. The type of transaction and the purpose may be obtained via the ID record associated with such a communication, which may be populated by detector engine 203 as discussed above.

Furthermore, as stated above, such information may be used by the artificial intelligence model to identify such alternative digital ID documents. Furthermore, as discussed above, the artificial intelligence model may use the trust level obtained from the trust model and the confidence level obtained from the confidence model to identify such alternative digital ID documents as discussed above.

If there were no alternative digital ID documents that were identified by the model, then ID document generator 205 informs the verifier that alternative digital ID documents are not available. If, however, there are alternative digital ID documents available, then ID document generator 205 may instruct computing device 103 of the verifier to complete the verification process by using one or more of such alternative digital ID documents.

A further description of these and other functions is provided below in connection with the discussion of the method for verifying that a user meets the ID requirements for an associated activity or event using an alternative set of digital ID documents than previously requested by the verifier.

Prior to the discussion of the method for verifying that a user meets the ID requirements for an associated activity or event using an alternative set of digital ID documents than previously requested by the verifier, a description of the hardware configuration of authentication system 105 is provided below in connection with FIG. 3.

Referring now to FIG. 3, FIG. 3 illustrates an embodiment of the present disclosure of the hardware configuration of an authentication system 105 (FIG. 1) which is representative of a hardware environment for practicing the present disclosure.

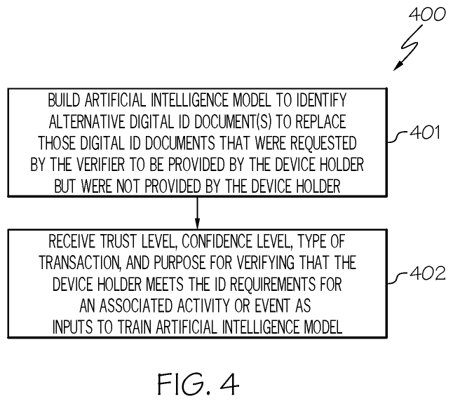

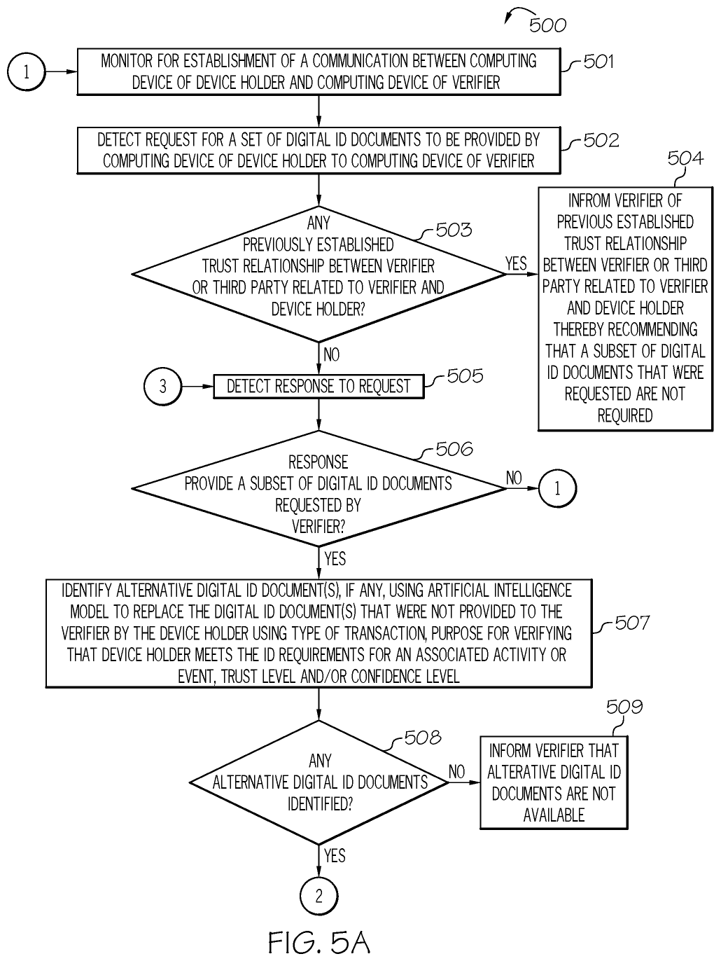

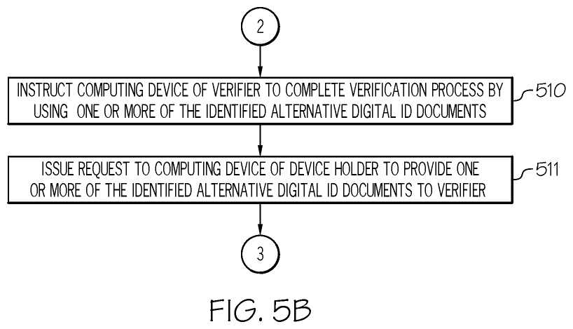

Authentication system 105 has a processor 301 connected to various other components by system bus 302. An operating system 303 runs on processor 301 and provides control and coordinates the functions of the various components of FIG. 3. An application 304 in accordance with the principles of the present disclosure runs in conjunction with operating system 303 and provides calls to operating system 303 where the calls implement the various functions or services to be performed by application 304. Application 304 may include, for example, machine learning engine 201 (FIG. 2), monitor engine 202 (FIG. 2), detector engine 203 (FIG. 2), analyzer 204 (FIG. 2) and ID document generator 205 (FIG. 2). Furthermore, application 304 may include, for example, a program for verifying that a user meets the ID requirements for an associated activity or event using an alternative set of digital ID documents than previously requested by the verifier as discussed further below in connection with FIGS. 4 and 5A-5B.

Referring again to FIG. 3, read-only memory (“ROM”) 305 is connected to system bus 302 and includes a basic input/output system (“BIOS”) that controls certain basic functions of authentication system 105. Random access memory (“RAM”) 306 and disk adapter 307 are also connected to system bus 302. It should be noted that software components including operating system 303 and application 304 may be loaded into RAM 306, which may be authentication system's 105 main memory for execution. Disk adapter 307 may be an integrated drive electronics (“IDE”) adapter that communicates with a disk unit 308, e.g., disk drive. It is noted that the program for verifying that a user meets the ID requirements for an associated activity or event using an alternative set of digital ID documents than previously requested by the verifier, as discussed further below in connection with FIGS. 4 and 5A-5B, may reside in disk unit 308 or in application 304.

Authentication system 105 may further include a communications adapter 309 connected to bus 302. Communications adapter 309 interconnects bus 302 with an outside network (e.g., network 104) to communicate with other devices, such as computing devices 101, 103.

In one embodiment, application 304 of authentication system 105 includes the software components of machine learning engine 201, monitor engine 202, detector engine 203, analyzer 204 and ID document generator 205. In one embodiment, such components may be implemented in hardware, where such hardware components would be connected to bus 302. The functions discussed above performed by such components are not generic computer functions. As a result, authentication system 105 is a particular machine that is the result of implementing specific, non-generic computer functions.

In one embodiment, the functionality of such software components (e.g., machine learning engine 201, monitor engine 202, detector engine 203, analyzer 204 and ID document generator 205) of authentication system 105, including the functionality for verifying that a user meets the ID requirements for an associated activity or event using an alternative set of digital ID documents than previously requested by the verifier, may be embodied in an application specific integrated circuit.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated above, currently, institutions, such as government agencies (e.g., department of motor vehicles), issue identity or identification cards or documents which may be used to identify a person or verify aspects of a person's personal identity. Identity or identification documents may include, for example, a driver's license, a fishing license, a hunting license, a passport, a health insurance card, a firearm owner's identification card, a boating license, a commercial driver's license, etc. Typically, such documents are issued in the form of a thermal plastic card or paper by these institutions (also referred to as “issuer”) based on user data (e.g., name, address, birthdate, height, etc. of the user) stored in databases. Unfortunately, by relying upon thermal plastic cards or paper, there are several drawbacks. For example, when a user presents an identity or identification document, such as to a verifier (responsible for determining if the user meets the identification (ID) requirements for an associated activity or event, such a merchant), there is no choice but to present the entire identity or identification document which may include personal information that is not needed to be seen by the verifier. For example, a merchant does not need to know the address of the individual when the individual is purchasing alcoholic beverages to verify that the individual is over 21 years of age. However, when the individual presents a driver's license to the merchant, the merchant will have access to information besides the age of the individual, such as the name and address of the individual. As a result, technologies, such as IBM® Verify Credentials, were developed to support a trusted, secure ecosystem for the management and exchange of “digital identifications” (also referred to as “digital IDs,” “digital ID documents” or “digital identification documents”). A digital ID document is the electronic equivalent of an individual identity card as well as other forms of user information, such as pay stubs, utility bills, restaurant receipts, etc. A digital ID document can be presented electronically to prove an individual's identity and/or their right to partake in an activity or event or to access information or services. Furthermore, the digital ID document can include attributes selected by the user to be presented to the verifier, such as the age of the user, thereby preventing other information that was not selected by the user (e.g., home address) from being shared to the verifier. As a result, the user has control as to what personal information will be shown to the verifier. However, there are times when the user may desire to provide alternative digital ID documents than the digital ID documents requested by the verifier. For example, the user may not possess the requested “standard ID” or may be reluctant to show such document(s) to the verifier. Unfortunately, there is not currently a means for identifying such alternative electronic documents (digital ID documents) to be provided to the verifier in order to complete the verification process in determining if the user meets the ID requirements for an associated activity or event.

The embodiments of the present disclosure provide a means for identifying alternative digital ID documents to be provided to the verifier in order to complete the verification process in determining if the user meets the ID requirements for an associated activity or event as discussed below in connection with FIGS. 4 and 5A-5B. FIG. 4 is a flowchart of a method for creating an artificial intelligence model for identifying alternative digital ID documents. FIGS. 5A-5B are a flowchart of a method for verifying that a user meets the ID requirements for an associated activity or event using alternative digital ID documents.

As stated above, FIG. 4 is a flowchart of a method 400 for creating an artificial intelligence model for identifying alternative digital ID documents in accordance with an embodiment of the present disclosure.

Referring to FIG. 4, in conjunction with FIGS. 1-3, in step 401, machine learning engine 201 of authentication system 105 builds an artificial intelligence model to identify alternative digital ID document(s) to replace those digital ID documents that were requested by the verifier to be provided by the device holder but were not provided by the device holder.

In step 402, machine learning engine 201 of authentication system 105 receives the trust level, confidence level, type of transaction and purpose for verifying that the device holder (e.g., device holder 102) meets the ID requirements for an associated activity or event as inputs to train the artificial intelligence model.

As discussed above, machine learning engine 201 uses a machine learning algorithm (e.g., supervised learning) to build an artificial intelligence model based on sample data consisting of digital ID documents, including alternative digital ID documents, that were requested by the verifiers and provided by the device holders as well as the associated type of transaction, the purpose for verifying that the device holder (e.g., device holder 102) meets the ID requirements for an associated activity or event, the trust level (e.g., level of probability in which the alternative set of digital ID document(s) will be accepted by the verifier to replace those digital ID documents that were previously requested by the verifier but not provided by the device holder) and a confidence level (confidence that the verifier has in verifying that the device holder meets the ID requirements for an associated activity or event using such an alternative set of digital ID documents). As previously discussed, such information may be stored in the ID records which are stored in database 106.

Such a data set is referred to herein as the “training data,” which is used by the machine learning algorithm to make predictions or decisions as to the appropriate alternative set of digital ID documents to be recommended to replace those digital ID documents that were requested by the verifier but not provided by the device holder. In one embodiment, the training data consists of digital ID documents, including alternative digital ID documents, that was requested by the verifier and provided by the device holder as well as the associated type of transaction, the purpose for verifying that the device holder (e.g., device holder 102) meets the ID requirements for an associated activity or event, a trust level (e.g., level of probability in which the alternative set of digital ID document(s) will be accepted by the verifier to replace those digital ID documents that were previously requested by the verifier but not provided by the device holder) and a confidence level (confidence that the verifier has in verifying that the device holder meets the ID requirements for an associated activity or event using such an alternative set of digital ID documents). The algorithm iteratively makes predictions on the training data as to the appropriate alternative set of digital ID documents to be recommended to replace those digital ID documents that were requested by the verifier but not provided by the device holder. Examples of such supervised learning algorithms include nearest neighbor, Naïve Bayes, decision trees, linear regression, support vector machines and neural networks.

In one embodiment, the artificial intelligence model (machine learning model) corresponds to a classification model trained to predict which digital ID documents should be recommended to replace those digital ID documents that were requested by the verifier but not provided by the device holder.

In one embodiment, the trust level is determined based on prior uses of such alternative digital ID documents to replace those digital ID documents that were previously requested by the verifier but not provided by the device holder. As discussed above, in one embodiment, the “trust level” refers to the level of probability in which the alternative set of digital ID document(s) will be accepted by the verifier to replace those digital ID documents that were previously requested by the verifier but not provided by the device holder. In one embodiment, such a trust level is established by machine learning engine 201 using a machine learning algorithm (e.g., supervised learning) to build a trust model based on sample data consisting of the alternative set of digital ID documents that were selected to replace those digital ID documents that were previously requested by the verifier but not provided by the device holder as well as the acceptance rate of such alternative digital ID documents by the verifier. The “acceptance rate,” as used herein, refers to the rate that such selected alternative digital ID documents were requested by the verifier to be provided by the device holder to complete the verification process in determining whether the device holder meets the ID requirements for an associated activity or event. Such a data set is referred to herein as the “training data,” which is used by the machine learning algorithm to make predictions or decisions as to the probability in which an alternative set of digital ID documents will be accepted by the verifier to replace those digital ID documents that were previously requested by the verifier but not provided by the device holder. The algorithm iteratively makes predictions on the training data as to the probability in which an alternative set of digital ID documents will be accepted by the verifier to replace those digital ID documents that were previously requested by the verifier but not provided by the device holder. Examples of such supervised learning algorithms include nearest neighbor, Naïve Bayes, decision trees, linear regression, support vector machines and neural networks.

In one embodiment, the trust model (machine learning model) corresponds to a classification model trained to predict the probability in which an alternative set of digital ID documents will be accepted by the verifier to replace those digital ID documents that were previously requested by the verifier but not provided by the device holder.

In one embodiment, the trust level is a bidirectional trust index that is based on the classification of the verifier and the device holder, such as device holder 102. Such a bidirectional trust index refers to the reliability in effectively verifying by the verifier that the device holder meets the ID requirements for an associated activity or event using the digital ID documents provided by the device holder.

In one embodiment, the classification for the verifier is based on data, such as based on the corporate size of the verifier (e.g., national retail chain versus a local hardware store), the type of corporate entity (e.g., privately held company, government institution), the location of the verifier (e.g., local government, foreign government), etc. Such information regarding the classification of the verifier may be obtained from the profile of the verifier, which is populated by the verifier upon utilizing system 100 to interact with computing device 101 of device holder 102 in order for the verifier to determine if such a device holder 102 meets the ID requirements for an associated activity or event.

Furthermore, the classification of the device holder, such as device holder 102, may be based on the geolocation data, the percentage of negotiations involving a verifier in which the device holder was deemed to be trusted, etc. In one embodiment, such geolocation data is obtained from monitor engine 202 as discussed above. Furthermore, the percentage of negotiations involving a verifier in which the device holder was deemed to be trusted, etc. is based on historical records (e.g., ID records) stored in database 106 associated with such a device holder, which are established by detector engine 203 as discussed above.

Additionally, as stated above, the trust level is a bidirectional trust index that is based on the classification of the verifier and the device holder, such as device holder 102. For example, a verifier that is a foreign government may have a lower trust level (lower trust level index) than a local government as there may be an increased risk of the device holder not providing the requested digital ID documents to a foreign government versus a local government. In another example, a device holder that has engaged in numerous successful negotiations with the verifier (e.g., numerous successful verification processes in which the device holder was successfully verified to meet the ID requirements for an associated activity or event) may have a higher trust level (higher trust level index) than if the device holder only had a single successful verification process with the verifier.

In one embodiment, the trust model is built based on sample data consisting of the reliability in effectively verifying by the verifier that the device holder meets the ID requirements for an associated activity or event using the digital ID documents provided by the device holder based on different classifications of the device holder and the verifier. Such a data set is referred to herein as the “training data,” which is used by the machine learning algorithm to make predictions or decisions as to the trust level or the reliability in effectively verifying by the verifier that the device holder meets the ID requirements for an associated activity or event using the digital ID documents provided by the device holder based on such classifications. The algorithm (supervised learning algorithm) iteratively makes predictions on the training data as to the trust level or probability in effectively verifying by the verifier that the device holder meets the ID requirements for an associated activity or event using the digital ID documents provided by the device holder based on classifications of the device holder and the verifier. Examples of such supervised learning algorithms include nearest neighbor, Naïve Bayes, decision trees, linear regression, support vector machines and neural networks.

In one embodiment, the trust model (machine learning model) corresponds to a classification model trained to predict the trust level or probability in effectively verifying by the verifier that the device holder meets the ID requirements for an associated activity or event using the digital ID documents provided by the device holder based on the classifications of the device holder and the verifier.

In one embodiment, the bidirectional trust index is utilized to determine whether it is safe to share requested digital ID documents by the device holder to the verifier based on the trust index of the verifier and whether it is safe to request digital ID documents from the device holder by the verifier based on the trust index of the device holder. For example, authentication system 105 may inform the device holder, such as device holder 102, via computing device 101 that it is safe to share the requested digital ID documents to the verifier since the trust index for the verifier indicates a high level of trust. Conversely, authentication system 105 may inform the device holder, such as device holder 102, via computing system 101 that is not safe to share the requested digital ID documents to the verifier since the trust index for the verifier indicates a low level of trust. In another example, authentication system 105 may inform the verifier via computing device 103 that it is safe to request and receive the digital ID documents, including alternative digital ID documents, from the device holder, such as device holder 102, since the trust index for the device holder indicates a high level of trust. Conversely, authentication system 105 may inform the verifier via computing device 103 that it is not safe to request and receive the digital ID documents, including alternative digital ID documents, from the device holder, such as device holder 102, since the trust index for the device holder indicates a low level of trust.

Furthermore, as discussed above, a confidence level may be used by machine learning engine 201 to identify an alternative set of digital ID documents. The “confidence level,” as used herein, refers to a confidence that the verifier has in verifying that the device holder meets the ID requirements for an associated activity or event using the alternative set of digital ID documents. In one embodiment, such a confidence level may be expressed in terms of a probability, such as a probability in successfully completing the verification process in verifying that the device holder meets the ID requirements for an associated activity or event using such alternative digital ID documents.

In one embodiment, such a confidence level is established by machine learning engine 201 using a machine learning algorithm (e.g., supervised learning) to build a confidence model based on sample data consisting of the alternative set of digital ID documents that were selected to replace those digital ID documents that were previously requested by the verifier but not provided by the device holder as well as the success rate in completing the verification process in verifying that the device holder meets the ID requirements for an associated activity or event using such alternative digital ID documents. The “success rate,” as used herein, refers to the rate that the verification process successfully verified that the device holder meets the ID requirements for an associated activity or event using such alternative digital ID documents. Such a data set is referred to herein as the “training data,” which is used by the machine learning algorithm to make predictions or decisions as to the confidence level or probability in which the verification process successfully verified that the device holder meets the ID requirements for an associated activity or event using the alternative set of digital ID documents. The algorithm iteratively makes predictions on the training data as to the confidence level or probability in which the verification process successfully verified that the device holder meets the ID requirements for an associated activity or event using the alternative set of digital ID documents. Examples of such supervised learning algorithms include nearest neighbor, Naïve Bayes, decision trees, linear regression, support vector machines and neural networks.

In one embodiment, the confidence model (machine learning model) corresponds to a classification model trained to predict the confidence level or probability in which the verification process successfully verified that the device holder meets the ID requirements for an associated activity or event using the alternative set of digital ID documents.

In one embodiment, the confidence level outputted by the confidence model corresponds to a value or score, such as a number between 0 and 1, which represents the likelihood that the verification process successfully verified that the device holder meets the ID requirements for an associated activity or event using the alternative set of digital ID documents. In one embodiment, each prediction has a confidence score. In one embodiment, the lower the confidence score, the lower the confidence that the verification process will successfully verify that the device holder meets the ID requirements for an associated activity or event using the alternative set of digital ID documents. Conversely, the higher the confidence score, the higher the confidence that the verification process will successfully verify that the device holder meets the ID requirements for an associated activity or event using the alternative set of digital ID documents.

Exemplary software tools for creating such confidence models include, but not limited to, ThingWorx® Composer, PI System®, Mosaic®, etc.

After building the artificial intelligence model, such a model may be used to identify alternative digital ID documents for the digital ID documents that were requested by the verifier but not provided by the device holder in order to complete the verification process (i.e., complete the process in verifying that the device holder meets the ID requirements for an associated activity or event) as discussed below in connection with FIGS. 5A-5B.

FIGS. 5A-5B are a flowchart of a method 500 for verifying that a user meets the ID requirements for an associated activity or event using alternative digital ID documents in accordance with an embodiment of the present disclosure.

Referring to FIG. 5A, in conjunction with FIGS. 1-4, in step 501, monitor engine 202 of authentication system 105 monitors for the establishment of a communication between computing device 101 of device holder 102 and computing device 103 of the verifier.

As stated above, such connections may involve the establishment of a communication between such computing devices via various means, such as Bluetooth, cellular, near-field communication, etc.

Such monitoring may be accomplished by monitor engine 202 using various software tools, including, but not limited to, SolarWinds® Server & Application Monitor, Datadog®, Zabbix®, Dynatrace®, LogicMonitor®, Sumo Logic®, etc.

In one embodiment, such monitoring may include obtaining the geolocation information of computing device 101 of device holder 102 and the geolocation information of computing device 103 of the verifier. A “geolocation,” as used herein, refers to the geographical (latitudinal and longitudinal) location of a network connected device. In one embodiment, such geolocation information is obtained by monitor engine 202 via a geolocation API which requests permission from the browser of computing devices 101, 103 to access their location data. In one embodiment, such geolocation information forms part of the device holder's response to the verifier's request for providing the digital ID documents.

In step 502, detector engine 203 of authentication system 105 detects the request from computing device 103 of the verifier for a set of digital ID documents (e.g., pay stub in last 30 days) to be provided to computing device 103 of the verifier by computing device 101 of the device holder, such as device holder 102, in order to verify that the device holder meets the ID requirements for the associated activity or event.

As discussed above, such detecting may be accomplished by detector engine 203 using various software tools including, but not limited to, SolarWinds® Network Performance Monitor, Paessler® Network Monitor, ManageEngine® NetFlow Analyzer, Savvius Omnipeek, Wireshark®, Telerik® Fiddler, Colasoft® Capsa, etc.

In step 503, analyzer 204 of authentication system 105 determines whether there has been any previously established trust relationship between the verifier (e.g., Home Depot®) or a related third party (e.g., Lowes®) and device holder 102 upon detector engine 203 detecting a request issued by the verifier to device holder 102 to provide a set of digital ID documents to the verifier.

As stated above, in one embodiment, previous established trust relationships between verifiers and device holders are stored in database 106, such as in a data structure (e.g., table). A “trust relationship,” as used herein, refers to a secure communication channel between computing device 103 of a verifier and computing device 101 of a device holder, such as device holder 102, in which the sending of digital ID documents (requested by the verifier) to the verifier by the device holder, such as device holder 102, is permitted to occur. In one embodiment, such trust relationships may be detected by detector engine 203 based on detecting the requests and responses between the verifier and the device holder. Such information may be populated in a data structure (e.g., table) that includes a listing of verifiers with established trust relationships with various device holders. In one embodiment, such a data structure resides in a storage device (e.g., memory 305, disk unit 309) of authentication system 105.

Furthermore, in one embodiment, verifiers may be cross-referenced with other verifiers in the data structure that are related, such as by industry. For example, the verifier of Home Depot® may be deemed to be related to the verifier of Lowes® since both merchants are in the home improvement service. In one embodiment, such cross-referencing is populated in the data structure by an expert. In one embodiment, such cross-referencing is stored in a list maintained in the data structure discussed above or in a separate data structure (e.g., table). Such a separate data structure may also be stored in a storage device (e.g., memory 305, disk unit 308) of authentication system 105. As a result, if a device holder has a trust relationship with Home Depot®, then such a trust relationship may be deemed to be valid with Lowes® even though the device holder may not have previously provided digital ID documents to such a merchant.

In one embodiment, upon detector engine 203 detecting a request issued by the verifier to the device holder to provide a set of digital ID documents to the verifier, analyzer 204 is configured to search in the data structure discussed above for a matching pair of the verifier (or related verifier) and device holder involved in the detected request. For example, if the request involves the verifier of Home Depot® and the device holder, then analyzer 204 is configured to search in the data structure for a matching pair of the verifiers Home Depot® or Lowes® (related verifier) and the device holder.

If such a matching pair is identified in the data structure, then analyzer 204 is configured to inform the verifier of a previously established trust relationship between the verifier (or a related third party verifier) and the device holder thereby recommending that a subset of the digital ID documents are not required. In one embodiment, such a recommended set of digital ID documents corresponds to those digital ID documents that were previously provided by the device holder to the verifier (or a related third party verifier) as indicated in the ID records of database 106. For example, the identifications of the particular digital ID documents that were provided by the device holder to the verifier (or related third party verifier) may have been previously stored in the ID record associated with such a validation process.

Referring to step 503, if there has been a previously established trust relationship between the verifier (e.g., Home Depot®) or a related third party (e.g., Lowes®) and device holder 102, then, in step 504, analyzer 204 of authentication system 105 informs the verifier of a previously established trust relationship between the verifier (or a related third party verifier) and the device holder thereby recommending that a subset of the digital ID documents that were requested are not required.

In one embodiment, in such a scenario, the verifier may accept the recommendation to withdraw the request for one or more of the digital ID documents previously requested. As a result, computing device 103 of the verifier may issue a new request to computing device 101 of device holder 102 for a different set of digital ID documents. The response to such a request is detected by detector engine 203 in step 505 as discussed below.

If, however, there has not been a previously established trust relationship between the verifier (e.g., Home Depot®) or a related third party (e.g., Lowes®) and device holder 102 or upon informing the verifier of a previously established trust relationship between the verifier (or a related third party verifier) and the device holder, then, in step 505, detector engine 203 of authentication system 105 detects a response by computing device 101 of device holder 102 to the request to provide a set of digital ID documents issued by the verifier.

As discussed above, such detecting may be accomplished by detector engine 203 using various software tools including, but not limited to, SolarWinds® Network Performance Monitor, Paessler® Network Monitor, ManageEngine® NetFlow Analyzer, Savvius Omnipeek, Wireshark®, Telerik® Fiddler, Colasoft® Capsa, etc.

In step 506, analyzer 204 of authentication system 105 determines whether the response provided a subset of the digital ID documents requested by the verifier. For example, the verifier may have requested the digital ID documents of a government issued badge and a pay stub issued in the last 7 days. However, device holder 102 may have only provided a government issued badge.

As discussed above, in one embodiment, such a determination is performed by analyzer 204 utilizing natural language processing to identify a list of digital ID documents requested by the verifier for device holder 102 to provide and to identify which digital ID documents from the list of digital ID documents were actually provided by device holder 102 in the response.

In one embodiment, a possible list of digital ID documents to be requested by the verifier and provided by the device holder is listed in a data structure (e.g., table). In one embodiment, such a data structure is populated by an expert. In one embodiment, analyzer 204 is configured to identify a digital ID document requested by the verifier in the request issued by the verifier by matching a term in the request with one of the keywords in the data structure that identifies a digital ID document using natural language processing. Furthermore, in one embodiment, analyzer 204 is configured to identify a digital ID document in the response issued by the device holder, such as device holder 102, by matching a term in the response with one of the keywords in the data structure that identifies a digital ID document using natural language processing. By comparing such digital ID documents identified in the request and response, analyzer 204 determines which, if any, of the digital ID documents that were requested by the verifier were not provided by the device holder. In one embodiment, such a data structure is stored in the storage device (e.g., memory 305, disk unit 308) of authentication system 105.

If analyzer 204 determines that all of the requested digital ID documents were provided by device holder 102, then monitor engine 202 of authentication system 105 continues to monitor for the establishment of a communication between computing device 101 of a device holder and computing device 103 of the verifier in step 501.

If, however, analyzer 204 determines that a subset of the digital ID documents that were requested by the verifier were not provided by device holder 102, including identifying which particular digital ID documents were not provided by device holder 102, then, in step 507, ID document generator 205 of authentication system 105 identifies alternative digital ID document(s), if any, using the artificial intelligence model to replace the digital ID document(s) that were not provided to the verifier by the device holder using the transaction type, the purpose for verifying that the device holder meets the ID requirements for an associated activity or event, the trust level and/or the confidence level.

As stated above, in one embodiment, detector engine 203 is configured to determine the type of transaction involved in the communication between the verifier and device holder 102 based on reviewing the profile of device holder 102 stored in database 106 that contains information about the device holder, such as the client type (e.g., government employee). In one embodiment, such a profile was populated by device holder 102 upon utilizing system 100 to interact with computing device 103 of the verifier in order for the verifier to determine if device holder 102 meets the ID requirements for an associated activity or event. In one embodiment, the transaction type is identified in the profile associated with the device holder in question using natural language processing in which keywords, such as “transaction type” or “client type,” in the profile are identified thereby enabling detector engine 203 to determine the type of transaction based on the word(s) following such keywords in the profile. In one embodiment, such information is used to populate an ID record associated with the device holder involved in such a communication.

In one embodiment, detector engine 203 is configured to determine the purpose for verifying that the device holder (e.g., device holder 102) meets the ID requirements for an associated activity or event based on the activity or event mentioned in the request provided by the verifier to the device holder, such as device holder 102. In one embodiment, detector engine 203 uses natural language processing to identify such activities or events. In one embodiment, a data structure (e.g., table) contains a listing of keywords (e.g., “opening checking account”) associated with various activities or events. In one embodiment, such a data structure is populated by an expert. In one embodiment, detector engine 203 analyzes the request issued by the verifier to identify such keywords listed in the data structure using natural language processing thereby identifying the purpose for verifying that the device holder (e.g., device holder 102) meets the ID requirements for an associated activity or event. In one embodiment, such information is used to populate an ID record associated with the device holder involved in such a communication.

As discussed above, in one embodiment, ID document generator 205 inputs various information to the artificial intelligence model, such as the digital ID documents that were not provided by device holder 102 as requested by the verifier, the type of transaction (e.g., government employee) and/or the purpose for verifying that the device holder (e.g., device holder 102) meets the ID requirements for an associated activity or event. The listing of the digital ID documents that were not provided by device holder 102 is obtained by analyzer 204. The type of transaction and the purpose may be obtained via the ID record associated with such a communication, which may be populated by detector engine 203 as discussed above.

As stated above, such information may be used by the artificial intelligence model to identify such alternative digital ID documents. Furthermore, as discussed above, the artificial intelligence model may use the trust level obtained from the trust model and the confidence level obtained from the confidence model to identify such alternative digital ID documents as discussed above.

In step 508, ID document generator 205 of authentication system 105 determines whether any alternative digital ID documents were identified.

If there were no alternative digital ID documents that were identified by ID document generator 205, then, in step 509, ID document generator 205 of authentication system 105 informs the verifier (computing device 103 of the verifier) that alternative digital ID documents are not available.

Referring to FIG. 5B, in conjunction with FIGS. 1-4, if, however, there are alternative digital ID documents available, then, in step 510, ID document generator 205 of authentication system 105 instructs computing device 103 of the verifier to complete the verification process by using one or more of such alternative digital ID documents. That is, ID document generator 205 instructs computing device 103 of the verifier to complete the verification of the device holder meeting the ID requirements for the associated activity or event by requesting one or more of the alternative digital ID documents from computing device 101 of device holder 102.

As discussed above, in one embodiment, the alternative digital ID documents provided by the artificial intelligence model are provided in a ranked order based on the likelihood that such alternative digital ID documents will be accepted by the verifier and the likelihood that such alternative digital ID documents will be successful in verifying that the device holder meets the ID requirements for an associated activity or event using such alternative digital ID documents. In one embodiment, such ranking is based on the trust level and the confidence level as established by the trust and confidence models discussed above. In one embodiment, the higher the ranking, the greater the likelihood that the associated alternative digital ID document will be accepted by the verifier and will be successful in verifying that the device holder meets the ID requirements for an associated activity or event using such alternative digital ID documents. Conversely, the lower the ranking, the lesser the likelihood that the associated alternative digital ID document will be accepted by the verifier and will be successful in verifying that the device holder meets the ID requirements for an associated activity or event using such alternative digital ID documents.

In step 511, upon receipt of the instruction from authentication system 105, computing device 103 of the verifier issues a request to computing device 101 of device holder 102 to provide one or more of the identified alternative digital ID documents to the verifier. In one embodiment, the verifier decides which of the alternative digital ID documents provided by ID document generator 205 to use to complete the verification process in verifying that device holder 102 meets the ID requirements (e.g., licensed for activity, age) for an associated activity or event. Such a selection may be reflected in a subsequent request that is issued to device holder 102 which includes a new listing of digital ID documents for device holder 102 to provide in order to compete the verification process. Such a new listing of digital ID documents includes the alternative digital ID documents recommended by ID document generator 205 to be requested by the verifier to complete the verification process.

After computing device 103 of the verifier issues such a request, detector engine 203 of authentication system 105 detects a response by computing device 101 of device holder 102 to the request to provide digital ID document(s) to the verifier in step 505.

If there are still digital ID document(s) that were not provided by device holder 102 to the verifier at the request of the verifier, then the process continues to step 507 to identify additional alternative digital ID documents. Otherwise, once the verification process is completed, monitor engine 202 of authentication system 105 continues to monitor for the establishment of a communication between computing device 101 of a device holder and computing device 103 of the verifier in step 501.

In this manner, the principles of the present disclosure identify digital ID documents to replace those digital ID documents that were requested by the verifier but not provided by the user. Such replacement digital ID documents may then be requested by the verifier to be provided by the user in order to complete the verification process in verifying that the user has met the ID requirements for an associated activity or event.

Furthermore, the principles of the present disclosure improve the technology or technical field involving identification (ID) documents.

As discussed above, currently, institutions, such as government agencies (e.g., department of motor vehicles), issue identity or identification cards or documents which may be used to identify a person or verify aspects of a person's personal identity. Identity or identification documents may include, for example, a driver's license, a fishing license, a hunting license, a passport, a health insurance card, a firearm owner's identification card, a boating license, a commercial driver's license, etc. Typically, such documents are issued in the form of a thermal plastic card or paper by these institutions (also referred to as “issuer”) based on user data (e.g., name, address, birthdate, height, etc. of the user) stored in databases. Unfortunately, by relying upon thermal plastic cards or paper, there are several drawbacks. For example, when a user presents an identity or identification document, such as to a verifier (responsible for determining if the user meets the identification (ID) requirements for an associated activity or event, such a merchant), there is no choice but to present the entire identity or identification document which may include personal information that is not needed to be seen by the verifier. For example, a merchant does not need to know the address of the individual when the individual is purchasing alcoholic beverages to verify that the individual is over 21 years of age. However, when the individual presents a driver's license to the merchant, the merchant will have access to information besides the age of the individual, such as the name and address of the individual. As a result, technologies, such as IBM® Verify Credentials, were developed to support a trusted, secure ecosystem for the management and exchange of “digital identifications” (also referred to as “digital IDs,” “digital ID documents” or “digital identification documents”). A digital ID document is the electronic equivalent of an individual identity card as well as other forms of user information, such as pay stubs, utility bills, restaurant receipts, etc. A digital ID document can be presented electronically to prove an individual's identity and/or their right to partake in an activity or event or to access information or services. Furthermore, the digital ID document can include attributes selected by the user to be presented to the verifier, such as the age of the user, thereby preventing other information that was not selected by the user (e.g., home address) from being shared to the verifier. As a result, the user has control as to what personal information will be shown to the verifier. However, there are times when the user may desire to provide alternative digital ID documents than the digital ID documents requested by the verifier. For example, the user may not possess the requested “standard ID” or may be reluctant to show such document(s) to the verifier. Unfortunately, there is not currently a means for identifying such alternative electronic documents (digital ID documents) to be provided to the verifier in order to complete the verification process in determining if the user meets the ID requirements for an associated activity or event.

Embodiments of the present disclosure improve such technology by detecting a request for a set of digital ID documents (e.g., utility bill, driver's license, birth certificate) to be provided to the computing device of the verifier by the computing device of the device holder in order to verify that the user (or “device holder”) meets the ID requirements for an associated activity or event. A response to the request is then detected which provides only a subset of the requested digital ID documents. One or more alternative digital ID documents are then identified to replace the digital ID document(s) that were requested but not provided by the device holder. In one embodiment, such alternative digital ID document(s) are identified using an artificial intelligence model based on various factors, such as the type of transaction, the purpose for verifying that the device holder meets the ID requirements for an associated event or activity, a trust level and/or a confidence level. The “type of transaction,” as used herein, refers to the categorization of the device holder (e.g., government employee) involved in the communication with the verifier. In one embodiment, the “trust level” refers to the level of probability in which the alternative set of digital ID document(s) will be accepted by the verifier to replace those digital ID documents that were previously requested by the verifier but not provided by the device holder. The “confidence level,” as used herein, refers to a confidence that the verifier has in verifying that the device holder meets the ID requirements for an associated activity or event using the alternative set of digital ID document(s). An instruction is then issued to the computing device of the verifier to request one or more of the identified alternative digital ID documents from the computing device of the device holder in order to complete the verification process in determining if the device holder meets the ID requirements for an associated activity or event. In this manner, the principles of the present disclosure identify digital ID documents to replace those digital ID documents that were requested by the verifier but not provided by the user. Such replacement digital ID documents may then be requested by the verifier to be provided by the user in order to complete the verification process in verifying that the user has met the ID requirements for an associated activity or event. Furthermore, in this manner, there is an improvement in the technical field involving identification (ID) documents.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for verifying a user meets identification (ID) requirements for an associated activity or event, the method comprising:
detecting a request for a set of digital ID documents to be provided to a computing device of a verifier by a computing device of a device holder in order to verify said device holder meets said ID requirements for said associated activity or event;
detecting a response to said request that provides a subset of said set of digital ID documents to said computing device of said verifier from said computing device of said device holder;
identifying one or more alternative digital ID documents to replace one or more digital ID documents in said set of digital ID documents that were requested but not provided in said subset of said set of digital ID documents; and
instructing said computing device of said verifier to complete verification of said device holder meeting said ID requirements for said associated activity or event by requesting one or more of said one or more alternative digital ID documents from said computing device of said device holder.

2. The method as recited in claim 1, wherein said one or more alternative digital ID documents are identified based on a type of transaction and a purpose for verifying said device holder meets said ID requirements for said associated activity or event.

3. The method as recited in claim 2, wherein said instruction comprises a ranked list of said one or more alternative digital ID documents based on said type of transaction and said purpose for verifying said device holder meets said ID requirements for said associated activity or event.

4. The method as recited in claim 1, said one or more alternative digital ID documents are identified based on a trust level in using said one or more alternative digital ID documents to verify said device holder meets said ID requirements for said associated activity or event and based on a confidence level corresponding to a confidence said verifier has in verifying said device holder meets said ID requirements for said associated activity or event using said one or more alternative digital ID documents.

5. The method as recited in claim 4, wherein said trust level is based on a classification of said verifier and said device holder.

6. The method as recited in claim 1 further comprising:
determining whether a trust relationship has previously been established between said verifier and said device holder in response to detecting said request for said set of digital ID documents to be provided to said computing device of said verifier by said computing device of said device holder.

7. The method as recited in claim 1 further comprising:
monitoring for establishment of a communication between said computing device of said device holder and said computing device of said verifier.

8. A computer program product for verifying a user meets identification (ID) requirements for an associated activity or event, the computer program product comprising one or more computer readable storage mediums having program code embodied therewith, the program code comprising programming instructions for:
detecting a request for a set of digital ID documents to be provided to a computing device of a verifier by a computing device of a device holder in order to verify said device holder meets said ID requirements for said associated activity or event;
detecting a response to said request that provides a subset of said set of digital ID documents to said computing device of said verifier from said computing device of said device holder;
identifying one or more alternative digital ID documents to replace one or more digital ID documents in said set of digital ID documents that were requested but not provided in said subset of said set of digital ID documents; and
instructing said computing device of said verifier to complete verification of said device holder meeting said ID requirements for said associated activity or event by requesting one or more of said one or more alternative digital ID documents from said computing device of said device holder.

9. The computer program product as recited in claim 8, wherein said one or more alternative digital ID documents are identified based on a type of transaction and a purpose for verifying said device holder meets said ID requirements for said associated activity or event.

10. The computer program product as recited in claim 9, wherein said instruction comprises a ranked list of said one or more alternative digital ID documents based on said type of transaction and said purpose for verifying said device holder meets said ID requirements for said associated activity or event.

11. The computer program product as recited in claim 8, said one or more alternative digital ID documents are identified based on a trust level in using said one or more alternative digital ID documents to verify said device holder meets said ID requirements for said associated activity or event and based on a confidence level corresponding to a confidence said verifier has in verifying said device holder meets said ID requirements for said associated activity or event using said one or more alternative digital ID documents.

12. The computer program product as recited in claim 11, wherein said trust level is based on a classification of said verifier and said device holder.

13. The computer program product as recited in claim 8, wherein the program code further comprises the programming instructions for:
determining whether a trust relationship has previously been established between said verifier and said device holder in response to detecting said request for said set of digital ID documents to be provided to said computing device of said verifier by said computing device of said device holder.

14. The computer program product as recited in claim 8, wherein the program code further comprises the programming instructions for:
monitoring for establishment of a communication between said computing device of said device holder and said computing device of said verifier.

15. A system, comprising:
a memory for storing a computer program for verifying a user meets identification (ID) requirements for an associated activity or event; and
a processor connected to said memory, wherein said processor is configured to execute program instructions of the computer program comprising:
detecting a request for a set of digital ID documents to be provided to a computing device of a verifier by a computing device of a device holder in order to verify said device holder meets said ID requirements for said associated activity or event;
detecting a response to said request that provides a subset of said set of digital ID documents to said computing device of said verifier from said computing device of said device holder;
identifying one or more alternative digital ID documents to replace one or more digital ID documents in said set of digital ID documents that were requested but not provided in said subset of said set of digital ID documents; and
instructing said computing device of said verifier to complete verification of said device holder meeting said ID requirements for said associated activity or event by requesting one or more of said one or more alternative digital ID documents from said computing device of said device holder.

16. The system as recited in claim 15, wherein said one or more alternative digital ID documents are identified based on a type of transaction and a purpose for verifying said device holder meets said ID requirements for said associated activity or event.

17. The system as recited in claim 16, wherein said instruction comprises a ranked list of said one or more alternative digital ID documents based on said type of transaction and said purpose for verifying said device holder meets said ID requirements for said associated activity or event.

18. The system as recited in claim 15, said one or more alternative digital ID documents are identified based on a trust level in using said one or more alternative digital ID documents to verify said device holder meets said ID requirements for said associated activity or event and based on a confidence level corresponding to a confidence said verifier has in verifying said device holder meets said ID requirements for said associated activity or event using said one or more alternative digital ID documents.

19. The system as recited in claim 18, wherein said trust level is based on a classification of said verifier and said device holder.

20. The system as recited in claim 15, wherein the program instructions of the computer program further comprise:
determining whether a trust relationship has previously been established between said verifier and said device holder in response to detecting said request for said set of digital ID documents to be provided to said computing device of said verifier by said computing device of said device holder.
